(19) United States
(12) Patent Application Publication
(10) Pub. No.: US 2015/0154627 A1
(43) Pub. Date: Jun. 4, 2015

(54) METHOD AND SYSTEM FOR IMPLEMENTING LIMITED USE OFFERS AT POINT OF SALE DEVICES

(71) Applicant: MasterCard International Incorporated, Purchase, NY (US)

(72) Inventor: Rohit CHAUHAN, Somers, NY (US)

(73) Assignee: MasterCard International Incorporated, Purchase, NY (US)

(21) Appl. No.: 14/095,020

(22) Filed: Dec. 3, 2013

(51) Int. Cl. G06Q 30/02; G06Q 20/40

(52) U.S. Cl. CPC G06Q 30/0225; G06Q 30/0238; G06Q 20/40

(57) ABSTRACT

A method for validating limited use offers includes: storing a plurality of offer data entries, each including an offer identifier, limitations on redemption, and a use flag; receiving an offer validation request including a specific offer identifier; identifying a specific offer data entry including the specific offer identifier; generating a notification regarding the validity of the offer when a use flag indicates that the offer has not been redeemed more than a specified number of times and the limitations on redemption of the specific offer data entry are satisfied, and indicates the offer as being invalid when the use flag indicates that the offer has been redeemed more than a specified number of times or one of the limitations on redemption of the specific offer data entry are not satisfied; and transmitting the generated notification.

### FIELD

The present disclosure relates to the validating of limited use offers, specifically the validation of an offer presented at a point-of-sale that is only redeemable once or a limited number of times by any consumer.

### BACKGROUND

Offers, such as coupons, deals, discounts, rewards, etc., are often used by merchants, manufacturers, retailers, offer providers, and other entities to increase consumer business. Merchants may hope to gain return customers who redeem an offer at their store, or may hope that customers shop at their store to redeem an offer and then buy additional products that recoup any potential loss of profits from the offer. Manufacturers may hope to gain a loyal customer who will provide repeat business following the purchase of a product using an offer. Offer providers may receive a commission for each consumer driven to a merchant, or may sell offers to consumers.

In some instances, merchants may provide an offer to consumers at a financial loss, such as by offering to sell an item for less than the item was purchased for by the merchant. Although such offers alone represent a loss, the savings provided by these types of offers may be very desirable to consumers, who may then visit the merchant to purchase the discounted item and also purchase additional goods in the process. The end result may be that the merchant receives a profit on additional goods, such as accessories for a high ticket electronic item, despite suffering a loss for the offer itself.

However, while such offers may be beneficial in some cases, there can be a number of risks associated with these kinds of offers. For example, consumers may not spend a sufficient amount on additional products to compensate for the loss, too much demand may result in insufficient stock, which could upset potential consumers, etc. As such, merchants may wish to limit the number of such offers that are distributed to consumers.

In some methods for limiting redemption, merchants may only distribute a predetermined number of offers as physical media. However, offers might be copied or represented, and this may be impractical in an age where consumers often expect to receive, select, and redeem offers electronically. In other methods, a merchant may keep a tally of the number of offers redeemed and no longer honor redemption after a predetermined number. However, such methods may be difficult to implement for a merchant and/or require significant resources to manage, and might result in customer disappointment. In addition, coordinating redemption among multiple locations may result in further difficulties for larger merchants.

Thus, there is a need for a technical solution for the validation of an offer that is redeemable only once for a merchant that utilizes a centralized database in order to provide for efficiency and effective communication while being suitable for use in legacy payment systems and thus not require new hardware or software for merchants.

### SUMMARY

The present disclosure provides a description of systems and methods for validating one-time or limited number use offers.

A method for validating one-time use offers includes: storing, in an offer database, a plurality of offer data entries, wherein each offer data entry includes data related to an offer for the purchase of goods or services including at least an offer identifier, one or more limitations on redemption, and a use flag; receiving, by a receiving device, an offer validation request, wherein the offer validation request includes at least a specific offer identifier; identifying, in the offer database, a specific offer data entry where the included offer identifier corresponds to the specific offer identifier; generating, by a processing device, a notification, wherein: the notification indicates the offer related to the specific offer data entry as being valid when the use flag of the specific offer data entry indicates that the related offer has not been redeemed more than a specified number of times (e.g., once, twice, etc.) and the one or more limitations on redemption of the specific offer data entry are satisfied, and the notification indicates the offer related to the specific offer data entry as being invalid when the use flag of the specific offer data entry indicates that the related offer has been redeemed more than a specified number of times or at least one of the one or more limitations on redemption of the specific offer data entry are not satisfied; and transmitting, by a transmitting device, the generated notification in response to the received offer validation request.

A system for validating one-time use offers includes an offer database, a receiving device, a processing device, and a transmitting device. The offer database is configured to store a plurality of offer data entries, wherein each offer data entry includes data related to an offer for the purchase of goods or services including at least an offer identifier, one or more limitations on redemption, and a use flag. The receiving device is configured to receive an offer validation request, wherein the offer validation request includes at least a specific offer identifier. The processing device is configured to: identify, in the offer database, a specific offer data entry where the included offer identifier corresponds to the specific offer identifier, and generate a notification. The notification indicates the offer related to the specific offer data entry as being valid when the use flag of the specific offer data entry indicates that the related offer has not been redeemed more than a specified number of times and the one or more limitations on redemption of the specific offer data entry are satisfied. The notification also indicates the offer related to the specific offer data entry as being invalid when the use flag of the specific offer data entry indicates that the related offer has been redeemed more than a specified number of times or at least one of the one or more limitations on redemption of the specific offer data entry are not satisfied. The transmitting device is configured to transmit the generated notification in response to the received offer validation request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for validating one-time use offers in accordance with exemplary embodiments.

FIG. 2 is a block diagram illustrating the processing server of FIG. 1 for the validation of one-time use offers in accordance with exemplary embodiments.

FIG. 3 is a flow diagram illustrating a method for processing a transaction including validation and redemption of a one-time use offer using the system of FIG. 1 in accordance with exemplary embodiments.

FIG. 4 is a flow diagram illustrating a method for validating and flagging a validated one-time use offer by the processing server of FIG. 1 in accordance with exemplary embodiments.

FIG. 5 is a flow diagram illustrating a method for processing a payment transaction including validation of a one-time use offer by the processing server of FIG. 1 in accordance with exemplary embodiments.

FIG. 6 is a flow chart illustrating an exemplary method for validating a one-time use offer in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Validating One-Time Use Offers

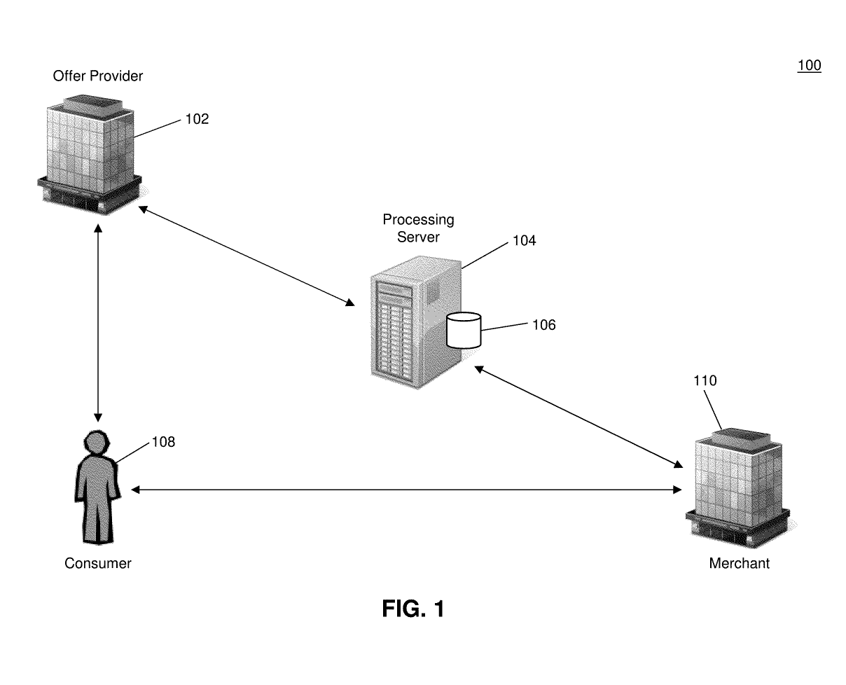

FIG. 1 illustrates a system 100 for the validation of offers that are redeemable for a single use.

The system may include an offer provider 102. The offer provider 102 may be any entity that may create and/or distribute offers, coupons, deals, discounts, etc. that may be valid for a single use, or for another specified number of times. The offer provider 102 may provide an offer and any associated offer data to a processing server 104. The processing server 104, discussed in more detail below, may store the offer and its associated data in an offer database 106.

The offer provider 102 may then distribute the offer to one or more consumers 108. In instances where the offer provider 102 may distribute a limited use offer to multiple consumers, only one consumer 108 (or a limited number of customers 108) may successfully redeem the offer. This may create a sense of urgency to the consumers who received the offer, to take advantage of the offer while they can, which may be of benefit to the offer provider 102 and/or merchants with whom the offer may be redeemed. In instances where the offer provider 102 may distribute a limited use offer to a single consumer 108, the consumer 108 may enjoy the benefit of an exclusive offer, while the offer provider 102 and merchant with which the offer may be redeemed may have the benefit of knowing the consumer 108 that will redeem the offer. Of course, instead of limiting the use of an offer to one time per offer or per customer, the offer can be limited to a specified number of uses, such as two or three uses, for example, in circumstances where attracting multiple uses by offering a repeating discount, such as in a tell-a-friend campaign or when multiple purchases might assure a higher level of adoption of the product or service, for example.

Limited use offers distributed by the offer provider 102 may be redeemed at a merchant 110. It will be apparent that, in some embodiments, the offer provider 102 and the merchant 110 may be a single entity. For instance, the consumer 108 may take the one-time use offer to the merchant 110. The merchant 110 may then submit an offer validation request to the processing server 104. The offer validation request may identify the offer that the consumer 108 presented for redemption, such as by including an offer identifier or other identifying value associated with the offer.

The processing server 104 may receive the request, and identify offer data associated with the offer in the offer database 106. The processing server 104 may then determine if the offer is valid. The offer may be valid if the offer has not yet been redeemed more than a specified number of times, and any additional offer criteria are satisfied. The additional criteria can optionally represent one or more limitations on redemption, such as no additional criteria, time period for valid redemption (e.g., start and/or end date limited, time of day limited, etc.), specific products or services, types of product or service, total amount of transaction, geographic location, or other factors or criteria that might be relevant or desired by the merchant, offer provider or other involved party. The processing server 104 may then notify the merchant 110 if the offer is valid or invalid based on the determination. The merchant 110 may then process the offer accordingly, but applying it to a transaction if it is valid, or informing the consumer 108 that it may not be redeemed if it is invalid.

In instances where the offer is valid for redemption, the merchant 110 may process a payment transaction that is modified based on redemption of the offer, such as including a reduced transaction amount based on an offer discount. If the transaction is successfully completed, the merchant 110 may notify the processing server 104 of successful completion of the transaction. The processing server 104 may then indicate in the offer database that the offer has been redeemed and thus would be invalid in future transactions. In such instances, the processing server 104 may wait to update the status of the offer in the offer database 106 until receipt of the notification from the merchant 110, as the offer may be valid as determined by the processing server 104, yet go unredeemed by the consumer 108 at the merchant 110. For example, the consumer 108 may lack sufficient funds to pay for a transaction, which may lead to the transaction being canceled, and the offer thus going unredeemed.

The processing server 104 may thus act as a centralized processor for validating limited use offers. As such, a one-time use offer, for instance, may be distributed that is redeemable at a large number of merchants, and yet be quickly validated via the processing server 104 such that it is not inadvertently redeemed multiple times due to lack of communication among merchants. In addition, by performing the validation of one-time use offers at the centralized processing server 104, rather than at the merchant 110 point of sale, the merchant 110 may not be required to upgrade, change, or otherwise modify their existing payment systems, depending on implementation.

For example, the offer validation request may be submitted to the processing server 104 using existing payment rails, such as those used for submission of an authorization request. In some instances, an offer validation request may accompany an authorization request for the transaction, such as by including the data in an additional data field of the authorization request. In such an instance, one-time use offers may be validated when presented to a merchant 110 with minimal effect on the systems of the merchant 110. In some embodiments, the processing server 104 may be part of a payment network and be configured to process payment transactions using methods and systems that will be apparent to persons having skill in the relevant art. In such an embodiment, the processing server 104 may be configured to validate a one-time use offer as well as process the transaction for redemption of the validated offer.

### Processing Server

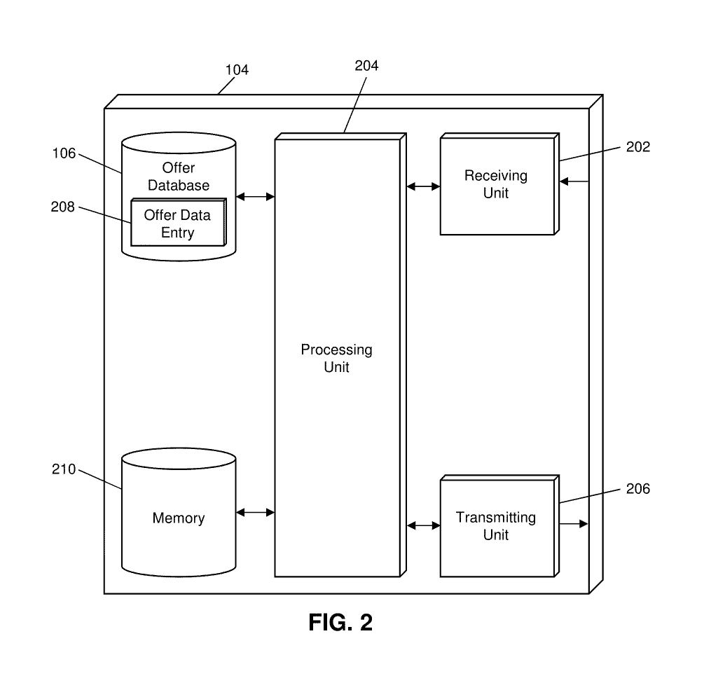

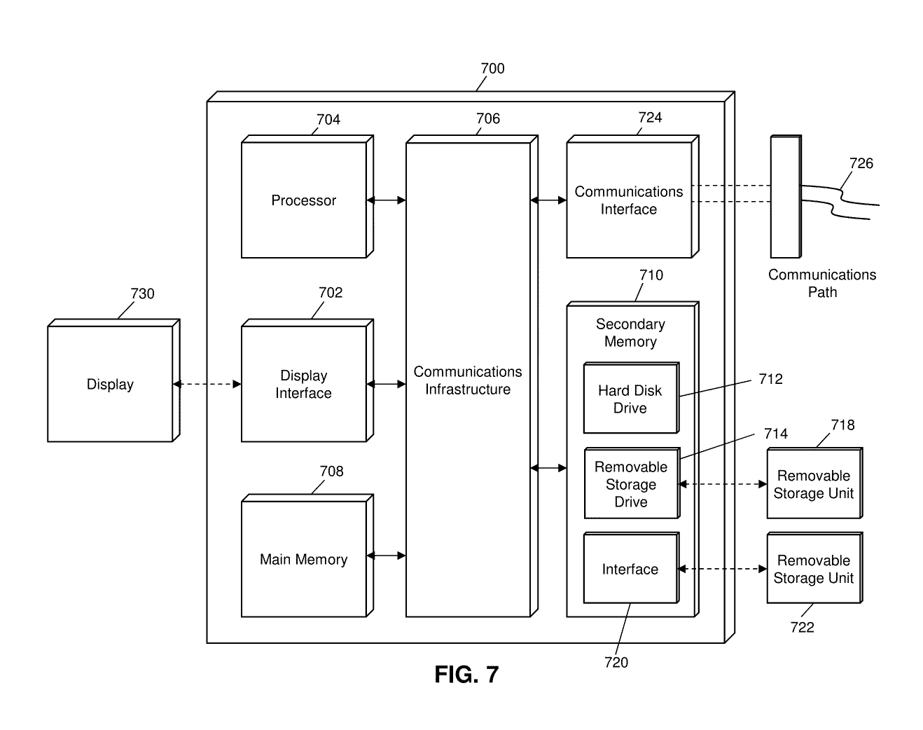

FIG. 2 illustrates an embodiment of the processing server 104 of the system 100. It will be apparent to persons having skill in the relevant art that the embodiment of the processing server 104 illustrated in FIG. 2 is provided as illustration only and may not be exhaustive to all possible configurations of the processing server 104 suitable for performing the functions as discussed herein. For example, the computer system 700 illustrated in FIG. 7 and discussed in more detail below may be a suitable configuration of the processing server 104.

The processing server 104 may include a receiving unit 202. The receiving unit 202 may be configured to receive data over one or more networks via one or more network protocols. The receiving unit 202 may receive offer information for one or more one-time use offers from the offer provider 102. The processing server 104 may further include a processing unit 204, which may be configured to identify the information received by the receiving unit 202, and store the information in the offer database 106 as one or more offer data entries 208.

Each offer data entry 208 may include data related to a one-time use offer including at least an offer identifier, one or more limitations on redemption, and a use flag. The offer identifier may be a unique value associated with the related one-time use offer used for identification of the related one-time use offer and/or the respective offer data entry 208. The offer identifier may be an identification number, universal product code, stock-keeping unit, registration number, or other suitable value as will be apparent to persons having skill in the relevant art. As mentioned above, the limitations on redemption may be limitations placed on the related limited use offer that are required to be satisfied in order for the offer to be redeemed. Limitations on redemption may include a start date, expiration date, time period for valid use. minimum transaction amount, maximum transaction amount, geographic location, or other factors or criteria that might be relevant or desired by the merchant, offer provider or other involved party, and merchant identifier associated with one or more merchants 110. Additional possible limitations will be apparent to persons having skill in the relevant art.

The use flag may be a flag, value, or other suitable metric for indicating if the related one-time use offer has already been redeemed. For example, the use flag may be a flag that indicates “Y” if the related offer has been redeemed more than a specified number of times (e.g., once, twice, etc.), and indicates “N” if the related offer has not been redeemed more than a specified number of times. Additional values suitable for use as the use flag will be apparent to persons having skill in the relevant art. In some embodiments, each offer data entry 208 may further include offer data associated with the related one-time use offer. Offer data may include, for example, an offer name, offer description, offer type, offer category, offer amount, transaction modifier, merchant name, merchant industry, merchant category, manufacturer data, product data, start date, expiration date, transaction amount, and geographic location.

The receiving unit 202 may be further configured to receive an offer validation request from the merchant 110. The offer validation request may include at least an offer identifier associated with a one-time use offer to which the offer validation request pertains. The processing unit 204 may be configured to identify an offer data entry 208 corresponding to the one-time use offer based on the included offer identifier. The processing unit 204 may then determine if the offer is valid based on the included use flag.

In some instances, the offer validation request may include additional data, such as transaction data corresponding to a payment transaction for which the one-time use offer is to be applied. The processing unit 204 may further base the validation of the one-time or limited use offer on satisfaction of the limitations of redemption included in the offer data entry 208 based on the additional data included in the offer validation request.

The processing server 104 may further include a transmitting unit 206. The transmitting unit 206 may be configured to transmit data over one or more networks via one or more network protocols. The transmitting unit 206 may transmit a validation response to the merchant 110 in response to the offer validation request, indicating if the one-time use offer is valid or invalid based on the determination of the processing unit 204.

The receiving unit 202 may be further configured to receive a notification, such as from the merchant 110, indicating that a validated one-time use offer has been successfully redeemed. The notification may include at least the offer identifier associated with the redeemed offer. The processing unit 204 may identify the corresponding offer data entry 208 in the offer database 106 that includes the offer identifier. The processing unit 204 may then update the use flag in the offer data entry 208 to indicate that the related limited use offer has already been redeemed more than a specified number of times.

The processing server 104 may further include a memory 210. The memory 210 may be configured to store additional data for use as discussed herein as will be apparent to persons having skill in the relevant art. For example, the memory 210 may be configured to store rules regarding determinations as to the limitations on redemption for a one-time use offer. The memory 210 may also be configured to store program code for execution by the processing unit 204 for the performing of the processing functions as disclosed herein.

### Process for Validation and Redemption of a Limited Use Offer

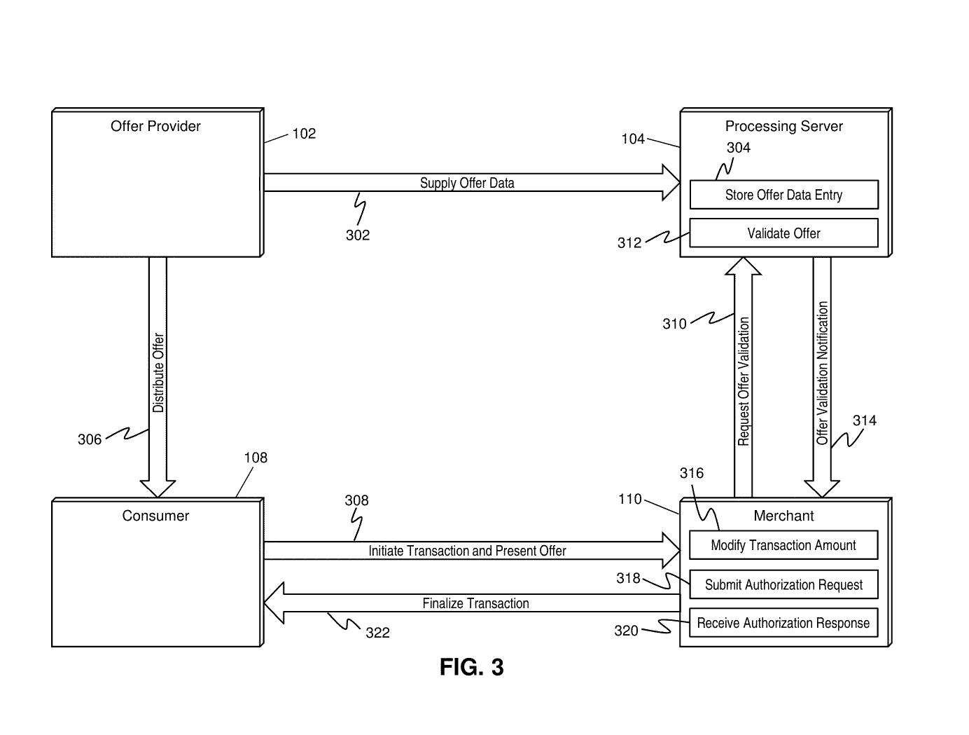

FIG. 3 illustrates a process for the validation of a one-time use offer presented by the consumer 108 and processing thereof by the merchant 110 and processing server 104.

In step 302, the offer provider 102 may supply offer data associated with a one-time use offer to the processing server 104. The processing server 104 may, in step 304, receive the offer data and store it as an offer data entry 208 in the offer database 106. In step 306, the offer provider 102 may distribute the limited use offer to the consumer 108.

In step 308, the consumer 108 may initiate a payment transaction with the merchant 110 and present the limited use offer for redemption in conjunction with the payment transaction. The limited use offer may be presented in a physical format (e.g., a printed offer), electronic format (e.g., via an e-commerce transaction, presentation on a mobile device, etc.), or any other suitable format as will be apparent to persons having skill in the relevant art. In step 310, the merchant 110 may submit an offer validation request to the processing server 104 for validation of the presented limited use offer.

In step 312, the processing server 104 may, as discussed in more detail below, validate the offer by determining that all limitations on redemption are satisfied and that the use flag for the offer indicates that it has not yet been redeemed more than a specified number of times. In step 314, the processing server 104 may transmit a notification to the merchant 110 indicating that the limited use offer is valid for redemption. In step 316, the merchant 110 may modify the transaction amount for the payment transaction based on the one-time use offer, such as by applying a discount provided by the offer.

In step 318, the merchant 110 (e.g., or an acquirer associated with the merchant 110) may submit an authorization request for the payment transaction to a payment network for processing. In step 320, the merchant 110 may receive an authorization response from the payment network indicating approval of the transaction. It will be apparent to persons having skill in the relevant art that steps 318 and 320 may be optional and may only be performed in instances where authorization of a payment method may be required. For example, steps 318 and 320 may not be performed in instances where the consumer 108 pays with cash.

Once the transaction has been approved, the merchant 110 may finalize the transaction with the consumer 108, in step 322. Finalization of the transaction may include furnishing the transacted-for goods or services to the consumer 108, providing a receipt for the transaction to the consumer 108, or other suitable actions. In some embodiments, the merchant 110 may submit a notification to the processing server 104 following completion of the transaction indicating redemption of the offer. The processing server 104 may then update the use flag for the offer indicating that the offer has been redeemed more than a specified number of times. In some instances, the merchant 110 may submit the notification to the offer provider 102. The offer provider 102 may then, in turn, notify the processing server 104 to update the use flag.

### Method for Validation of a Limited Use Offer

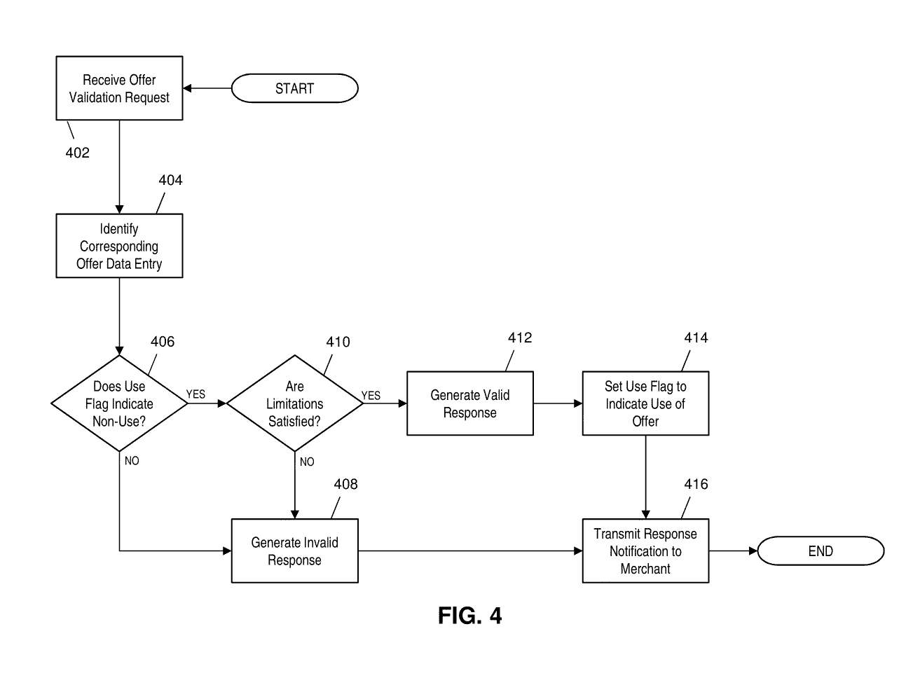

FIG. 4 illustrates a method for the validation of a limited use offer as performed by the processing server 104 of the system 100 of FIG. 1.

In step 402, the receiving unit 202 of the processing server 104 may receive an offer validation request from the merchant 110. The offer validation request may include at least an offer identifier associated with a limited use offer that is presented by the consumer 108 for redemption. In step 404, the processing unit 204 may identify, in the offer database 106, an offer data entry 208 that corresponds to the limited use offer based on the offer identifier included in the offer validation request. In step 406, the processing unit 204 may determine if the use flag included in the identified offer data entry 208 indicates that the offer has not yet been redeemed more than a specified number of times.

If the flag indicates that the offer has already been redeemed more than a specified number of times, and is thus invalid, then, in step 408, the processing unit 204 may generate a response to the offer validation request that indicates that the limited use offer is invalid. If the flag indicates that the offer has not be redeemed more than a specified number of times, then, in step 410, the processing unit 204 may determine if all limitations on redemption included in the identified offer data entry 208 are satisfied. In some instances, the determination may be based on additional data included in the offer validation request, such as transaction data. If the limitations on redemption are not satisfied, then, returning to step 408, the processing unit 204 may generate a response indicating that the one-time use offer is invalid. Of course, the flag could be set for a different value, such as to permit the use of the offer a limited number of times, e.g., twice, three times, etc., for example, to accommodate offer programs where more than one discount is viewed as appropriate to increase the likelihood of securing a recurring customer, for instance.

If the limitations are satisfied, then, in step 412, the processing unit 204 may generate a response to the offer validation request that indicates that the limited use offer is valid for redemption. In step 414, the processing unit 204 may update the use flag in the identified offer data entry 208 to indicate that the limited use offer has been redeemed, and if the offer has now been redeemed for a specified number of times, indicate that the offer is no longer valid. Then, in step 416, the transmitting unit 206 of the processing server 104 may transmit the generated response to the merchant 110. It will be apparent to persons having skill in the relevant art that, in some instances, step 414 may be an optional step. In other instances, step 414 may be performed in response to receipt, by the receiving unit 202, of a notification of successful completion of the payment transaction corresponding to the offer validation request.

### Method for Processing a Payment Transaction Including a One-Time Use Offer

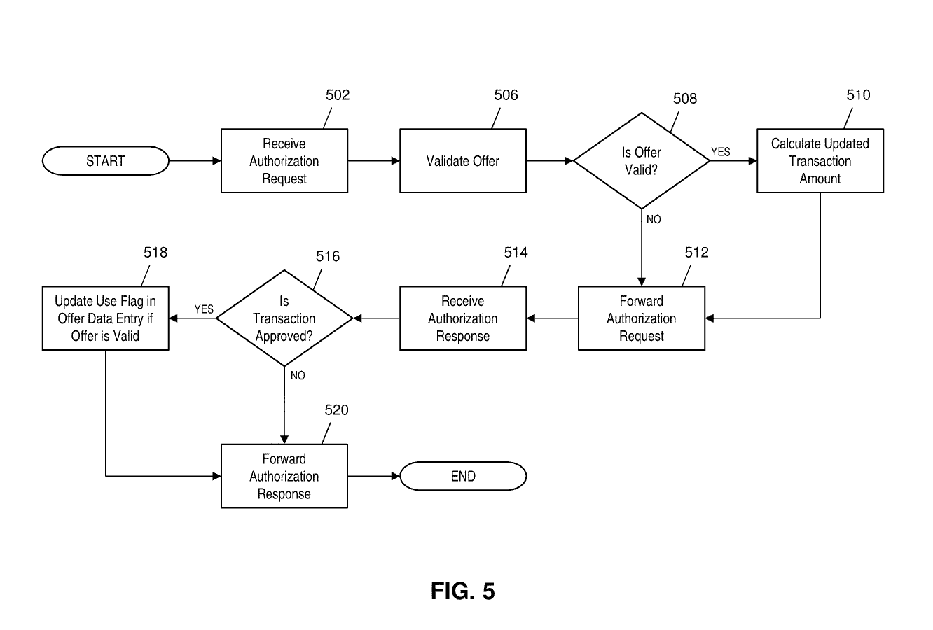

FIG. 5 illustrates a method for the processing of a payment transaction including validation and redemption a one-time use offer using the processing server 104 of the system 100 of FIG. 1.

In step 502, the receiving unit 202 of the processing server 104 may receive an authorization request for a payment transaction. The authorization request may include at least a transaction amount, transaction data, and an offer identifier associated with a limited use offer presented by the consumer 108. In step 506, the processing unit 204 may identify and validate the limited use offer, such as by using the method illustrated in FIG. 4 and discussed above. In step 508, the processing unit 204 may determine if the offer is valid based on the validation performed in step 506.

If the limited use offer is valid, then, in step 510, the processing unit 204 may calculate an updated transaction amount based on the transaction amount included in the authorization request and a transaction modifier or other data associated with the valid limited use offer (e.g., and included in the corresponding offer data entry 208). Once the transaction amount is updated, or if the limited use offer was determined to be invalid, then, in step 512, the transmitting unit 206 of the processing server 104 may forward the authorization request to a payment network and/or an issuer for approval or denial. In step 514, the receiving unit 202 may receive an authorization response indicating approval or denial of the payment transaction.

In step 516, the processing unit 204 may identify, as indicated in the authorization response, if the transaction is approved or denied. If the transaction is approved, and if the limited use offer was previously determined to be valid, then, in step 518, the processing unit 204 may update the use flag in the corresponding offer data entry 208 to indicate successful redemption of the one-time use offer. Once the authorization response has been received, and the use flag updated if necessary, then, in step 520, the transmitting unit 206 may forward the authorization response on to the merchant 110. If the transaction is not approved, the transmitting unit 206 may forward the authorization response to the merchant 110 without updating the use flag in the corresponding offer data entry 208. The authorization response may indicate approval or denial of the transaction, as well as if the one-time use offer was successfully validated and/or redeemed.

### Exemplary Method for Validating a One-Time Use Offer

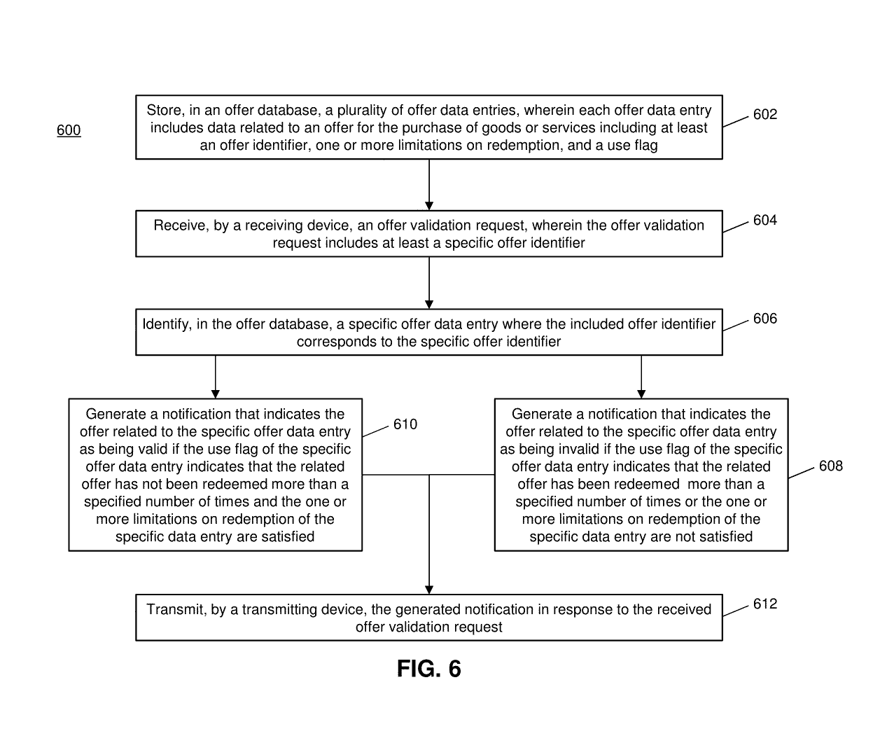

FIG. 6 illustrates a method 600 for the validation of a one-time use offer.

In step 602, a plurality of offer data entries (e.g., the offer data entries 208) may be stored, in an offer database (e.g., the offer database 106), wherein each offer data entry 208 includes data related to an offer for the purchase of goods or services including at least an offer identifier, one or more limitations on redemption, and a use flag. In one embodiment, the one or more limitations on redemption may include at least one of: a start date, an expiration date, a minimum transaction amount, a geographic location, and a merchant identifier, for example, as explained above.

In step 604, an offer validation request may be received, by a receiving device (e.g., the receiving unit 202), wherein the offer validation request includes at least a specific offer identifier. In one embodiment, the offer validation request may further include transaction data, the transaction data including at least one of: a transaction amount, a transaction time and/or date, a geographic location, a merchant identifier, and a device identifier. In step 606, a specific offer data entry 208 may be identified, in the offer database 106, where the included offer identifier corresponds to the specific offer identifier.

In step 608, a notification may be generated, by a processing device (e.g., the processing unit 204) that indicates the offer related to the specific offer data entry 208 as being invalid, if the use flag of the specific offer data entry 208 indicates that the related offer has been redeemed more than a specified number of times, or if the one or more limitations on redemption of the specific offer data entry 208 are not satisfied. In alternative step 610, a notification may be generated, by the processing device 204, that indicates the offer related to the specific offer data entry 208 as being valid if the use flag of the specific offer data entry 208 indicates that the related offer has not been redeemed more than a specified number of times and the one or more limitations on redemption of the specific data entry are satisfied.

In some embodiments, each offer data entry 208 may further include offer data, the offer data including at least one of: an offer name, offer description, offer type, offer category, offer amount, transaction modifier, merchant name, merchant industry, merchant category, manufacturer data, product data, start date, expiration date, transaction amount, and geographic location. In a further embodiment, the generated notification may further include the offer data included in the specific offer data entry 208 if the generated notification indicates the offer related to the specific offer data entry 208 as being valid.

In step 612, the generated notification may be transmitted, by a transmitting device (e.g., the transmitting unit 206), in response to the received offer validation request. In one embodiment, the method 600 may further include updating, in the offer database 106, the use flag of the specific offer data entry 208 to indicate that the related offer has been redeemed if the generated notification indicates the offer related to the specific offer data entry as being valid.

In some embodiments, each offer data entry 208 may further include a transaction modifier. In a further embodiment, the offer validation request may further include a transaction amount, and the method 600 may further include calculating, by the processing device 204, an updated transaction amount based on the transaction modifier included in the specific offer data entry 208 if the generated notification indicates that the offer related to the specific offer data entry 208 as being valid. In some of the further embodiments, the generated notification may include the calculated updated transaction amount.

In an even further embodiment, the method 600 may further include: updating, in the offer validation request, the included transaction amount based on the calculated updated transaction amount; and transmitting, by the transmitting device 206, the updated offer validation request to a payment network for processing of a payment transaction corresponding to the offer validation request. In a still further embodiment, the receiving device 202 may receive an authorization response indicating approval or denial of the payment transaction, wherein the generated notification further includes the received authorization response. In one embodiment, the method 600 may further include updating, in the offer database 106, the use flag of the specific offer data entry 208 to indicate that the related offer has been redeemed if the authorization response indicates approval of the payment transaction.

### Computer System Architecture

FIG. 7 illustrates a computer system 700 in which embodiments of the present disclosure, or portions thereof, may be implemented as computer-readable code. For example, the processing server 104 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor 704 may be a special purpose or a general purpose processor device. The processor 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for validating one-time use offers. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for validating limited use offers, comprising:
storing, in an offer database, a plurality of offer data entries, wherein each offer data entry includes data related to an offer for the purchase of goods or services including at least an offer identifier, one or more limitations on redemption, and a use flag;
receiving, by a receiving device, an offer validation request, wherein the offer validation request includes at least a specific offer identifier;
identifying, in the offer database, a specific offer data entry where the included offer identifier corresponds to the specific offer identifier;
generating, by a processing device, a notification, wherein
the notification indicates the offer related to the specific offer data entry as being valid when the use flag of the specific offer data entry indicates that the related offer has not been redeemed more than a specified number of times and the one or more limitations on redemption of the specific offer data entry are satisfied, and
the notification indicates the offer related to the specific offer data entry as being invalid when the use flag of the specific offer data entry indicates that the related offer has been redeemed more than the specified number of times or at least one of the one or more limitations on redemption of the specific offer data entry are not satisfied; and
transmitting, by a transmitting device, the generated notification in response to the received offer validation request.

2. The method of claim 1, further comprising:
updating, in the offer database, the use flag of the specific offer data entry to indicate that the related offer has been redeemed when the generated notification indicates the offer related to the specific offer data entry as being valid.

3. The method of claim 1, wherein the one or more limitations on redemption include at least one of: a start date, an expiration date, a minimum transaction amount, a geographic location, and a merchant identifier.

4. The method of claim 1, wherein the offer validation request further includes transaction data, the transaction data including at least one of: a transaction amount, a transaction time and/or date, a geographic location, a merchant identifier, and a device identifier.

5. The method of claim 1, wherein each offer data entry further includes offer data, the offer data including at least one of: an offer name, offer description, offer type, offer category, offer amount, transaction modifier, merchant name, merchant industry, merchant category, manufacturer data, product data, start date, expiration date, transaction amount, and geographic location.

6. The method of claim 5, wherein the generated notification further includes the offer data included in the specific offer data entry when the generated notification indicates the offer related to the specific offer data entry as being valid.

7. The method of claim 1, wherein each offer data entry further includes a transaction modifier.

8. The method of claim 7, wherein the offer validation request further includes at least a transaction amount, and the method further comprises:
calculating, by the processing device, an updated transaction amount based on the transaction modifier included in the specific offer data entry when the generated notification indicates that the offer related to the specific offer data entry as being valid.

9. The method of claim 8, wherein the generated notification further includes the calculated updated transaction amount.

10. The method of claim 8, further comprising:
updating, in the offer validation request, the included transaction amount based on the calculated updated transaction amount; and
transmitting, by the transmitting device, the updated offer validation request to a payment network for processing of a payment transaction corresponding to the offer validation request.

11. The method of claim 10, further comprising:
receiving, by the receiving device, an authorization response indicating approval or denial of the payment transaction, wherein
the generated notification further includes the indicated approval or denial of the payment transaction.

12. The method of claim 11, further comprising:
updating, in the offer database, the use flag of the specific offer data entry to indicate that the related offer has been redeemed when the authorization response indicates approval of the payment transaction.

13. A system for validating limited use offers, comprising:
an offer database configured to store a plurality of offer data entries, wherein each offer data entry includes data related to an offer for the purchase of goods or services including at least an offer identifier, one or more limitations on redemption, and a use flag;
a receiving device configured to receive an offer validation request, wherein the offer validation request includes at least a specific offer identifier;
a processing device configured to
identify, in the offer database, a specific offer data entry where the included offer identifier corresponds to the specific offer identifier, and
generate a notification, wherein
the notification indicates the offer related to the specific offer data entry as being valid when the use flag of the specific offer data entry indicates that the related offer has not been redeemed more than a specified number of times and the one or more limitations on redemption of the specific offer data entry are satisfied, and
the notification indicates the offer related to the specific offer data entry as being invalid when the use flag of the specific offer data entry indicates that the related offer has been redeemed more than a specified number of times or at least one of the one or more limitations on redemption of the specific offer data entry are not satisfied; and
a transmitting device configured to transmit the generated notification in response to the received offer validation request.

14. The system of claim 13, wherein the processing device is further configured to update, in the offer database, the use flag of the specific offer data entry to indicate that the related offer has been redeemed when the generated notification indicates the offer related to the specific offer data entry as being valid.

15. The system of claim 13, wherein the one or more limitations on redemption include at least one of: a start date, an expiration date, a minimum transaction amount, a geographic location, and a merchant identifier.

16. The system of claim 13, wherein the offer validation request further includes transaction data, the transaction data including at least one of: a transaction amount, a transaction time and/or date, a geographic location, a merchant identifier, and a device identifier.

17. The system of claim 13, wherein each offer data entry further includes offer data, the offer data including at least one of: an offer name, offer description, offer type, offer category, offer amount, transaction modifier, merchant name, merchant industry, merchant category, manufacturer data, product data, start date, expiration date, transaction amount, and geographic location.

18. The system of claim 17, wherein the generated notification further includes the offer data included in the specific offer data entry when the generated notification indicates the offer related to the specific offer data entry as being valid.

19. The system of claim 13, wherein each offer data entry further includes a transaction modifier.

20. The system of claim 19, wherein
the offer validation request further includes at least a transaction amount, and
the processing device is further configured to calculate an updated transaction amount based on the transaction modifier included in the specific offer data entry when the generated notification indicates that the offer related to the specific offer data entry as being valid.

21. The system of claim 20, wherein the generated notification further includes the calculated updated transaction amount.

22. The system of claim 20, wherein
the processing device is further configured to update, in the offer validation request, the included transaction amount based on the calculated updated transaction amount, and
the transmitting device is further configured to transmit the updated offer validation request to a payment network for processing of a payment transaction corresponding to the offer validation request.

23. The system of claim 22, wherein
the receiving device is further configured to receive an authorization response indicating approval or denial of the payment transaction, and
the generated notification further includes the indicated approval or denial of the payment transaction.

24. The system of claim 23, wherein the processing device is further configured to update, in the offer database, the use flag of the specific offer data entry to indicate that the related offer has been redeemed when the received authorization response indicates approval of the payment transaction.
